(19) United States
(12) Patent Application Publication
(10) Pub. No.: US 2008/0248801 A1
(43) Pub. Date: Oct. 9, 2008

(54) ACCESS TO LOCALLY RELEVANT SERVICES AND PERSONALLY RELEVANT SERVICES WITHIN A MOBILE COMMUNICATIONS ENVIRONMENT

(75) Inventors: Benjamin Joseph Fletcher, West Yorkshire (GB); Anthony Green, Helston Cornwall (GB); Claire Leckey, London (GB); Nial Peters, Cornwall (GB); John Brian Pickering, Hampshire (GB); Andrew James Stanford-Clark, Isle of Wight (GB); Matthew Wilson, Hants (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/852,527

(22) Filed: Sep. 10, 2007

(30) Foreign Application Priority Data
Apr. 3, 2007 (EP) 07105567.7

(51) Int. Cl. H04Q 7/20

(52) U.S. Cl. 455/435.2

(57) ABSTRACT

Accesses to locally-relevant and contextually-relevant services information within a mobile communications environment are enabled. The solutions include an improved location determination in which a first mobile communications device processes location information broadcast by other devices via short-range wireless signals to determine its approximate location. The described solutions include a context-based selection of the most relevant of a set of locally-available services, including filtering services according to whether the first mobile device is currently moving and filtering according to a personal profile of the device user.

### BACKGROUND OF THE INVENTION

The present invention provides apparatus, methods and computer programs enabling him access to locally-relevant and contextually-relevant services information within a mobile communications environment. The invention provides improved location determination and/or automated selection of a subset of the locally-available services that are likely to be of current interest to a particular mobile device user

A significant market is emerging for location-based services provided across mobile communications networks. This requires an identification of the location of each mobile device and service area. Information can be sent to each identified device to inform the device user about locally-available services and to notify the device user about local events. This market opportunity is generating considerable interest from mobile telephone service provider companies in their desire to offer new customer services and to differentiate themselves from their competitors. The market opportunity is also likely to be of interest to many other organizations since it enables information about products and services to be passed to potential customers at a particular time or situation when the products/services are likely to be of interest to those potential customers.

‘Location-based services’ can include local services such as transport services, hotels, restaurants or entertainment (i.e., any services that people use), but the term ‘location-based services’ in the context of this specification also refers to the service of providing locally-relevant information from an information source. For example, a mobile device user may be interested in travel related information such as departure times, event details such as locations and times, contact details for organizations, or other descriptions of local services such as restaurant or hotel guides. A device user may need to receive warnings such as fire alarm warnings or notifications relating to systems they are monitoring.

Most conventional location-finding systems rely on a central server that tells each mobile device where it is. This requires that the central server track the positions of a potentially huge number of mobile devices and then send location information to the mobile devices when the information is needed. Such a solution is described in U.S. Pat. No. 6,256,498.

Distributed systems in which the location-finding is done by the mobile device itself are known. Since each mobile device discovers its own location, location information never has to be stored by a central server or third party.

U.S. Pat. No. 5,938,721 describes using positioning information (obtained via a GPS satellite or similar) to index a database that stores a task description, to assist with task scheduling. The task description within the database includes a geographic location identifier or “geocode” corresponding to a location at which completion of the task may be facilitated.

Hariharan et al, “Web-Enhanced GPS”, Published February 2005 by Microsoft Corporation as a Microsoft Research paper and later submitted to Location- and Context-Awareness, Proceedings of First International Workshop, pages 95-104, Germany, 12-13 May 2005, describes taking location measurements from a GPS receiver and accessing location-tagged data that already exists on the Web. This avoids the need for a custom-written, location-sensitive database.

### BRIEF SUMMARY OF THE INVENTION

The invention may be embodied as a method for accessing services from a first mobile communication device. A set of devices other than the first mobile communication device is established by detecting wireless signals transmitted by the devices. A subset of devices, consisting of fixed-location devices, is established. Wireless signals transmitted by fixed-location devices in the subset are monitored to determine whether the first mobile communication device is moving relative to the fixed-location devices. Services are selected from a plurality of available services according to the determination of whether or not the first mobile device is moving relative to the fixed-location devices.

The invention may also be embodied as a computer program product for accessing services from a first mobile communication device. The computer program product includes a computer usable medium embodying computer usable program code. The program code includes code configured to establish a set of devices other than the first mobile communication device by detecting and transmitted wireless signals from other devices. The program code also includes code configured to identify a subset of detected devices consisting of fixed-location devices and code configured to monitor wireless signals transmitted by the fixed-location devices to determine whether the first mobile communication device is moving relative to the fixed-location devices. Finally, the program code includes code configured to select services from a plurality of available services according to a determination whether the first mobile communication device is moving relative to the fixed-location devices.

Finally, the invention may be embodied as a mobile communication apparatus. The apparatus includes means for establishing a set of devices other than the mobile communications apparatus by detecting wireless signals transmitted by other devices as well as means for establishing a subset of the detected devices consisting of fixed-location devices. The apparatus further includes means for monitoring wireless signals transmitted by of the fixed-location devices and logic means for determining from the monitored wireless signals whether the mobile communication device is moving relative to the fixed-location devices. Finally, the apparatus includes means for selecting services from a plurality of available services based on the determination whether the mobile communication device is moving relative to the fixed-location devices.

### BRIEF DESCRIPTION OF THE SEVERAL VIEWS OF THE DRAWINGS

FIG. 1 is a schematic representation of a communications network in which the present invention may be implemented.

FIG. 2 is a schematic representation of a set of devices performing a ‘search and discover’ detection of communication-partner devices for location determination according to an embodiment of the invention.

FIG. 3 represents use of location information broadcast by various devices to determine an approximate location of a mobile device.

FIG. 4 shows a network environment including a client portal application program and a publish/subscribe broker providing a portal service.

FIG. 5 shows a sequence of steps of a method for movement-determination according to an embodiment of the invention.

FIG. 6 shows a sequence of steps of a method for location-determination according to an embodiment of the invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

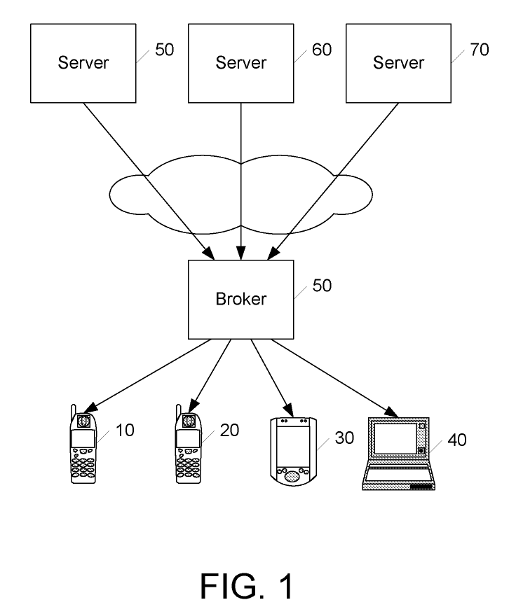

In the schematic network diagram of FIG. 1, several mobile communications devices 10,20,30,40 are shown as consumers of information published by a set of service providers 50,60,70. In this example, the information publishers send information via an intermediate broker 80 (or a broker network) which stores subscriptions specifying the information requirements of the subscriber mobile devices 10,20,30,40.

Such a publish/subscribe network is known in the art, for example using a message broker system such as a WebSphere Message Broker system from IBM Corporation. This system implements network routing and optionally message transformations in addition to the inherent scalability benefits of the publish/subscribe paradigm (the scalability arises from the avoidance of the need for dedicated point-to-point connections between the message senders and message recipients). IBM Corporation's WebSphere Message Broker is described in the documents “IBM WebSphere Message Broker Version 6 Release 0—Introduction”, IBM Corporation, July 2006, and “IBM WebSphere Message Broker Version 6 Release 0—Publish/Subscribe”, IBM Corporation, July 2006. WebSphere and IBM are trademarks of International Business Machines Corporation.

The transmission of messages from the broker 80 to the mobile communications devices 10,20,30,40 may implement a General Packet Radio Service (GPRS) link using a suitable transport protocol, such as the WebSphere MQ Telemetry Transport (MQTT) protocol, for example. MQTT is a lightweight TCP/IP-based messaging protocol that uses a low-overhead (2 byte) message header.

The mobile communications devices may include wireless-communications-enabled laptop computers, Personal Digital Assistants (PDAs) and mobile telephones (currently the most pervasive of all mobile communications devices), or other devices. In this particular embodiment, each of the mobile communications devices also implements a version of the Bluetooth wireless communication specifications for communications with other nearby devices. Other technologies such as WiFi may be used for discovery and communications with nearby devices, but for ease of understanding a first embodiment of the invention is described below with reference only to Bluetooth.

Bluetooth is a widely adopted standard for radio-frequency wireless communications that was designed for low power consumption and the dynamic establishment of personal area networks (PANs). Each Bluetooth device has a power-dependent range, which is currently of the order of 100 meters for 100 mW devices (Class 1 devices), 10 meters for 2.5 mW devices (Class 2 devices) and 1 meter for 1 mW devices (Class 3). Apart from its prevalence and low power requirements, significant advantages of Bluetooth include its simplification of automatic discovery of potential communication-partner devices and its automated configuration to set up services. Bluetooth devices broadcast an identification of the services they provide, together with a device class, a device name and some additional technical information such as device features, identification of the device manufacturer, a clock offset and an identification of the particular Bluetooth specification that is implemented. Any Bluetooth device may broadcast signals to seek other devices with which to connect, and any Bluetooth device may be configured to respond to such signals. Every device has a unique 48-bit address, which is not generally shown to communication partners (device names are generally used instead). Bluetooth is described in the IEEE 802.15.1 specifications.

WiFi to refers to technology underlying wireless local area networks (WLAN) based on the IEEE 802.11 specifications. Although developed for mobile communications devices, WiFi is also used for Internet-based services and connectivity between many consumer electronic devices.

A first embodiment of the present invention exploits the information broadcast by Bluetooth-enabled devices to detect movement and to determine the location of a mobile communications device. Bluetooth devices that know their current location with a reasonable level of confidence are able to broadcast that location information to other devices. Any devices that come within range of the broadcasting devices can then calculate their own approximate location. Furthermore, the device class information that is broadcast by each device (a feature of conventional Bluetooth service discovery communications) enables a recipient of broadcast location information to infer whether that location information was broadcast by a fixed-location device or a mobile device. By differentiating between different types of information provider device and the timestamps of their broadcasts, it is possible to differentiate between reliable and less reliable location information received from the different devices. The way in which this information is used is described in more detail below.

In a first embodiment of the invention, location information that is received by a mobile communications device from other mobile devices is disregarded for the purposes of location-determination whenever location information is also available from fixed-location devices. Information from the fixed-location devices is considered to be more reliable than similar information received from mobile devices. Following a description of this embodiment is a description of an alternative embodiment that identifies levels of reliability of received location information based on the category of each broadcasting device, but then makes use of location information that is broadcast by mobile devices as well as that broadcast by fixed-location devices.

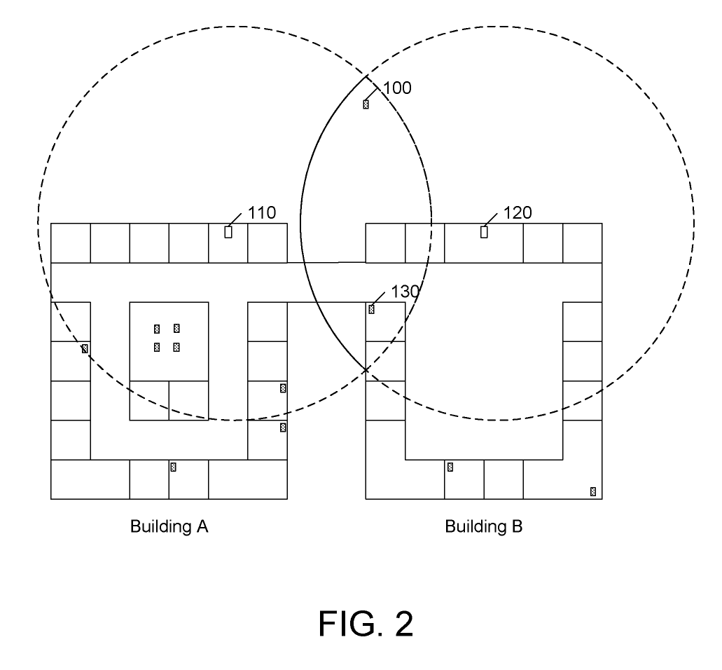

FIG. 2 is a simplified and schematic representation of a first mobile device 100 and its position relative to a number of other devices. Let us assume that the first mobile communications device 100 is a Bluetooth-enabled device that is capable of detecting three or more other Bluetooth devices 110,120,130 that are within 100 meters of the first mobile communications device. Let us assume that the first mobile communications device 100 and its three or more near neighbors are all 100 mW Class 1 Bluetooth devices, in which case they each have a transmission range of approximately 100 meters. Let us assume that one of the three near neighbors is a fixed-location printer 110, a second neighbor device is a fixed-location desktop computer 120, and the third neighbor is a mobile telephone 130. For the purposes of this illustration, any other detected neighbors are also mobile telephones.

Having detected the three or more near neighbors, the first mobile device refers to device class information broadcast by each near neighbor device. In this example, the first mobile device identifies one of these devices 130 as a mobile telephone (clearly not a fixed-location device) whereas two devices 110,120 are identified as being within classes of fixed-location devices. Any location information received from a mobile telephone is disregarded, since location information received from the fixed-location devices is considered to be more reliable. This is firstly because fixed-location devices are stationary, i.e. any received location information relates to their current position; and secondly because a typical mobile device will have approximated its own location from location information broadcast by other devices (rather than having a well-defined fixed location).

Now let's assume that the two fixed-location devices are in adjoining buildings within an office complex and that their respective broadcast locations are ‘Building A/Room 15’ and ‘Building B/Room 2’. The first mobile device can combine that information to determine that it lies within 100 meters of Room 15 and within 100 meters of Room 2. In some cases it may be impossible for the first mobile device to accurately resolve these two potentially valid locations to determine which building it is in. Some prior art solutions force a choice to be made such that a single (possibly incorrect) location is associated with each device. The inventors of the present invention have recognized that forcing a resolution can be unhelpful, especially when the resolved location implies a level of accuracy of location determination that cannot be substantiated.

According to the present embodiment, the two potentially valid locations (‘Building A/Room 15’ and ‘Building B/Room 2’) are both associated with the first mobile device. Thereafter, while the first mobile device remains at its current location, information that is relevant to either one or both of these locations is treated as relevant information by the first mobile device.

This association of a device with multiple locations complements an arrangement whereby locations and information topics are both organized hierarchically. For example, a security officer's mobile device that is able to approximately determine its location by detecting its proximity to devices broadcasting location information, may save two location identifiers:

“CompanyALocations/CentralLondon/Building A/Room 15’ and

‘CompanyALocations/CentralLondon/Building B/Room2’.

Let us assume that this information is obtained from broadcaster devices and saved, when the security officer visits on office complex identifiable as:

‘CompanyALocations/CentralLondon’.

The security officer can then be notified of events such as a fire alarm, a sensor notification indicating a window being opened, and other items—published on respective topics such as:

‘CompanyALocations/CentralLondon/BuildingA/FireAlarm’ and

‘CompanyALocations/CentralLondon/BuildingB/Room6/WindowSensor’ and

‘CompanyALocations/CentralLondon/SecurityAuditReportDue’

‘CompanyALocations/CentralLondon/BuildingA/CafeteriaClosing’

‘CompanyALocations/CentralLondon/BuildingB/CafeteriaClosing’

Note that published information may be determined to be relevant to one of the locations currently associated with the mobile device, and this does not necessarily require a determination to be made regarding which building is closest to the current location of the mobile device. Instead, information that is relevant to each of the potentially-valid locations is presented on the mobile device's display screen.

Let us assume that the security officer then moves towards Building A and assigns an employee to investigate the opened window at Building B. Certain published information may be deselected from the set of information that is presented to the mobile device user on the basis that it does not match a stored information selection profile when the user is moving, or simply because the device user has moved too far away from one of the buildings. For example, the notification that a security audit report is due may be unhelpful when the user is moving, but helpful when the user is stationary within their office. Information that a cafeteria in Building B is closing in 10 minutes may be relevant when the user is in that building, but of no interest to a user who is moving away from Building B towards Building A. In this example, the security officer's mobile device 100 detects its movement relative to the fixed-location devices 110,120 and automatically deselects certain information that was previously displayed to the user (in this example the information relating to the cafeteria in Building B). Other information may be re-arranged on the mobile device's display screen to take account of a change of priorities as a result of the security guard moving. The displayed topics are now:

Priority 1:

‘CompanyALocations/CentralLondon/BuildingA/FireAlarm’ and

‘CompanyALocations/CentralLondon/BuildingB/Room6/WindowSensor’ and

‘CompanyALocations/CentralLondon/BuildingA/CafeteriaClosing’

Priority 2:

‘CompanyALocations/CentralLondon/SecurityAuditReportDue’.

To enable movement to be used as a selection parameter for selecting or prioritizing information from the set of locally-relevant information, one embodiment of the present invention monitors the signal strength of Bluetooth signals that are received by a mobile device from identified fixed-location devices. The monitoring allows identification of a change to the received signal strength. Another embodiment does not measure signal strength numerically, but monitors the detectability of a transmitted signal over time. For example, if a previously detected fixed-location device is no longer detectable and yet a previously undetected fixed-location device has been detected, this implies that the mobile device has moved relative to these fixed-location devices. This identification of movement can be achieved with a very low monitoring overhead, and the determination that a mobile device is moving can be used in a number of ways.

In the current embodiment, the detection of movement is compared with a user's stored personal profile. The profile specifies which types of service they wish to access only when moving, which types of service they wish to access only when stationary, and which services they wish to access regardless of whether they are currently moving. In alternative embodiments, some types of information will be defined as inherently limited to stationary recipients (for example a notification of the current availability of a software patch is unlikely to be acted upon by any device user who is currently moving, and information relating to services at a train station can be assumed to be of no interest to a train passenger who is passing through that station on a high speed train). These are merely examples of how an identification of movement can influence the selection of services. The particular approach of detecting changes in signal strength of short-range wireless signals sent from fixed-location devices provides a low-overhead client-side mechanism for detecting movement and so enables movement to be used as a selection criterion.

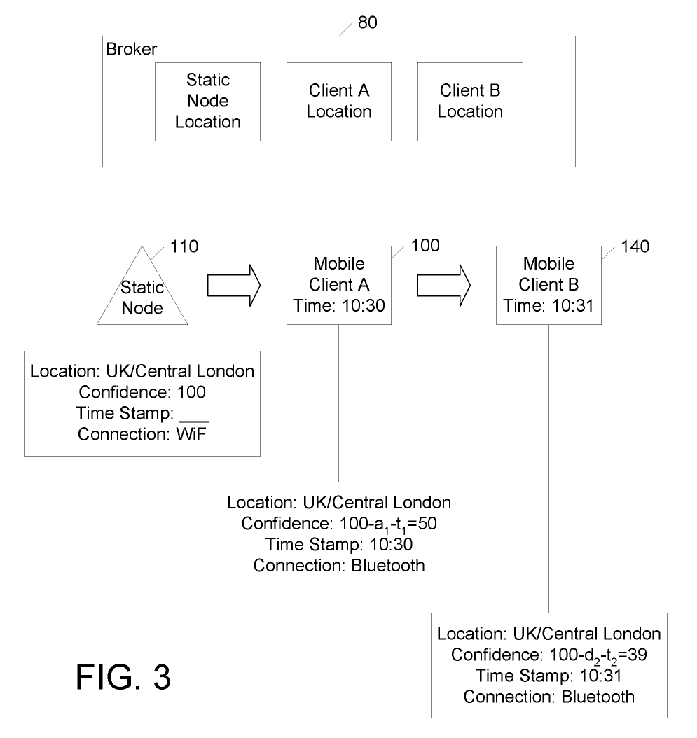

In an alternative embodiment, location information that is broadcast by nearby fixed-location and mobile devices can all be used in the determination of a mobile device's approximate location. More significance (i.e. a higher numeric weighting) is assigned to location information received from fixed-location devices than mobile devices; and more significance is assigned to recently broadcast information from mobile devices than to older information from mobile devices. A mobile client device locates itself by gathering location information from surrounding broadcasters over wireless connections. Location information is filtered by the client using metrics to determine its reliability. These metrics include a ‘confidence’ factor and a time stamp associated with the location information broadcast by any broadcaster device. On receiving location information the mobile client recalculates ‘confidence’ factors based on distance from each respective broadcaster. This is primarily found from the age of the information and the connection type, using signal strength and also the broadcast range for the connection type—e.g. 10 m for a Class 2 Bluetooth device, 45-100 meters for a basic WiFi device depending on whether it is inside a building or outside (and much longer range up to several kilometres for a WiFi device with a ‘state of the art’ antenna). The age of the information can be calculated using the current time and the timestamp. The larger the distance from the broadcaster, the more the ‘confidence’ factor is decreased. The greater the age of the information, the more the ‘confidence’ factor is decreased. Using the recalculated ‘confidence’, the mobile client device determines its potentially valid locations. Once the client has discovered its potential locations, it can then become a broadcaster, passing its own location information to other devices. This is represented schematically in FIG. 3.

A device 110 is a static device with a well-defined location such as ‘UK/CentralLondon’ (this is merely an illustrative example, in this case identifying the central London office location of the particular company employing the device user). The device 110 broadcasts this location via a WiFi signal together with an indication of its level of confidence in the broadcast location information (in this case 100% confidence). No timestamp is broadcast by static devices. A mobile client device 100, Client A, detects the static node 110 using WiFi signal discovery. Client A is able to determine its own approximate location by reference to the location of the static device 110. Client A identifies the location ‘UK/CentralLondon’ as its own location, but with a lower level of confidence than the level associated with the static device. The confidence level is reduced by a first factor representing the maximum possible distance of the device 100 from the static device 110, given the strength (or simply the detectability) of the detected WiFi signal. The confidence level is not affected by any time difference since the WiFi signal was broadcast by a static device. The confidence level may be represented as:

CONFIDENCE=Rₙ−dₙ−tₙ

where Rₙ represents the confidence level of the received location information (in this example R₁=100), dₙ represents the distance factor (for example d₁=50) and tₙ represents the relevant time difference factor (in this case t₁=0), such that

CONFIDENCE=R₁−d₁−t₁=50.

Having determined both a location and a confidence level associated with that location, Client A is now able to become a location broadcaster itself unless a restriction on such broadcasts has been defined by the device user or network administrator. Client A broadcasts its location via Bluetooth signals, including the information:

| LOCATION: | UK/CentralLondon |
|---|---|
| CONFIDENCE: | 50 |
| TIME STAMP: | 10:30. |

A second mobile device 140, Client B, is then able to determine its own approximate location from the signal broadcast by Client A. Client B receives the Bluetooth signal and determines its own location to be UK/CentralLondon, with a confidence level:

CONFIDENCE=R₂−d₂−t₂=50−10−1=39.

Client B may then become a location broadcaster as well, if its location confidence is above a defined threshold and there is no administrator-defined or user-defined restriction on such broadcasts. Assuming the location determination component within Client B approves this location broadcasting, Client B broadcasts the following information via Bluetooth signals:

| LOCATION: | UK/CentralLondon |
|---|---|
| CONFIDENCE: | 39 |
| TIME STAMP: | 10:31. |

As noted in the context of the first embodiment, a mobile client device can be identified as being potentially in multiple locations at once. That is, the location determination and location broadcasting are not limited to selection of only a single location if a plurality of potentially valid locations is identified. If there is insufficient data to differentiate between two or more potentially valid but distinct locations (e.g. if all locations appear equally valid), the client can be associated with all of them. If the received location information includes overlapping location definitions (such as ‘CompanyALocations/CentralLondon/BuildingA’ and ‘CompanyALocations/CentralLondon’), a mobile device can be associated with ‘CentralLondon’ and ‘CentralLondon/BuildingA’ to ensure that all locally-relevant information is provided to the device user.

It should be noted that each broadcaster device may broadcast its respective location as a single absolute location (if this is known) or as location information that is relative to the locations of other devices. A mobile device may broadcast a notification of its proximity to a detected nearby device instead of explicitly stating its location. The actual location of the detected nearby device may be separately broadcast by that nearby device or may be held at a separate server device such as a publish/subscribe message broker. This delegation of explicit location information to a broker may improve security. compared with networks in which every device explicitly broadcasts its absolute location. In this way, the individual client devices make use of self-discovery of communication partners and inferences regarding their relative proximity to particular categories of device, but an intermediate secure publish/subscribe broker takes responsibility for comparing and matching each device's location with published location-specific information. The location information can be protected using encrypted communications within a security-controlled network such as an intranet.

The above-described first and second embodiments are each implementable in a publish/subscribe messaging environment in which a set of information providers comprise publisher application programs running on a set of network-connected server computers, and in which the intermediate publish/subscribe broker comprises a portal server providing a portal service. The portal server passes published information to a set of registered subscribers including wireless-communication-enabled devices (e.g. Bluetooth devices) that each run a portal client application program to render a portal page on a display screen of the device.

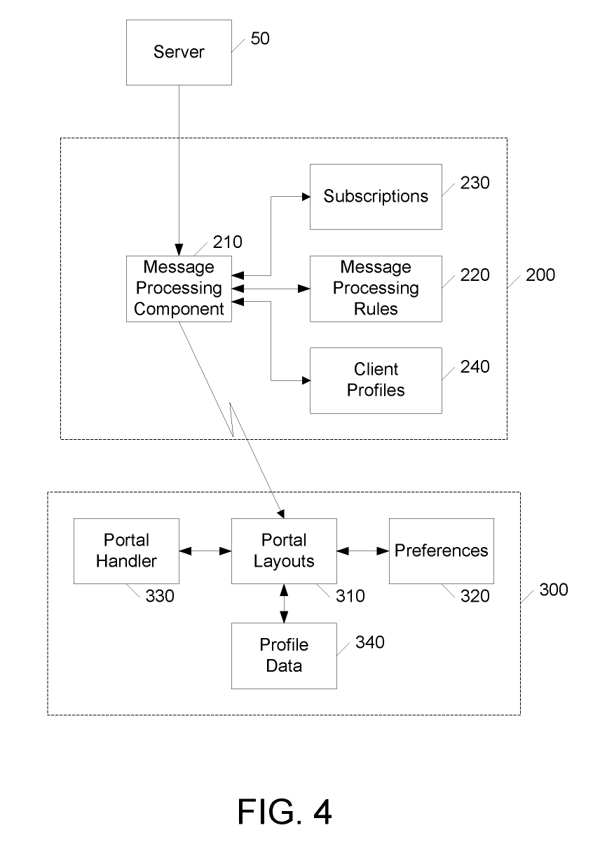

FIG. 4 shows the elements of the portal server 200 and an example portal client application program 300. The portal server comprises a message processing component 210 which receives input messages from publishers 50,60,70 (only one shown). The message processing component 210 implements a set of message processing rules 220 that define translations between the messages received from the data publishers and a message format for transmission to the client application programs. The message processing component also holds subscription data 230 for each portal client application program 300. The subscription data 230 is used by the message processing component 210 to identify messages that should be forwarded to particular portal client application programs. As described above, the message processing component may include IBM Corporation's WebSphere Message Broker system.

Messages from the message processing component 210 are received in the portal client application program by a portal manager component 310, which is arranged to manage the presentation and maintenance of portals on the client device. The portal manager 310 uses preference data 320, portal layouts 330 and personal profile data 340 for a device user, to determine the layout of the portal and how the data received from the publishers should be displayed within it. In the present embodiment, the portal client application program 300 can be implemented in the Java™ programming language as a thin client for use in small or mobile client devices. The transmission of messages between the portal server 200 and client application programs 300 may be carried out via a GPRS (General Packet Radio Service) link using MQ Telemetry Transport (MQTT) messaging technology.

In the present embodiment, the portal handler also stores personal profile data 340 that duplicates the subscription data 240 held by the message processing component 210. The version of this data stored on the client device enables a user or administrator to gain easier access and enables profile-based customizations of the selection and display of data to be performed on the client device. The portal client application program 300 manages the profile data 340 in parallel with management of the subscription data 240 by the message processing component 210. Where a device has more than one user, the profile data comprises an entry for each instance of the portal client application program, which equates to an individual user. Each entry is headed by a user identifier (userid) and comprises an ordered comma-delineated list of subscriptions for a given user as follows:

userid: message account[username,password], subscription 1, subscription 2, . . . , subscription n.

In the present embodiment, subscriptions can be one of two types. The first type is a description to one-to-one messages such as email messages, which are published by a data source, such as an email server 50, to the portal server 200. The publication of these messages is performed securely using a username and password for each identified message account in the list. The second type is a subscription to an information channel. The information channels comprise data published on predefined subjects which may be periodically updated and are identified in the list by a subscription name. In the present embodiment, when a user registers a client device for use with the portal server, an appropriate entry in the profile data is entered either by a portal server administrator or by the user. The profile data may be modified subsequently by the user or administrator as described below.

On receipt of published data, the message processing component 210 identifies the destination for the data from the subscription data 240 and, using the message rules 220, converts the data into an XML (Extensible Mark-up Language) message format for transmission to the appropriate client device. The message rules use XML tags to define the following elements of messages:

Msg—this marks the start and end of a given message.

Attribute—this identifies a characteristic of the message such as either message account name, a channel name or a user id. A channel name may be determined from the names of topics that are subscribed to.

From—this identifies the source of the data and is optional.

Subject—this identifies the subject of the data and is optional.

Body—this holds the message data.

As noted above, the portal layouts 330 define the layout of any portal page displayed on the client device. A portal page may comprise a number of portlets (i.e. separate user interface components within the portal page), each arranged to display data from an associated data source that has been subscribed to by the client device user. The number and layout of the portlets displayed on a given client device is determined dynamically by the portal handler 310 in dependence on the subscriptions associated with the device and location information and other contextual information. When a client device starts up an instance of the portal client application program 300, the device accesses the current set of subscriptions stored in the profile data 340. The portal handler 310 is then arranged to select a portal layout 330 depending on the subscription list and to map each subscription to an appropriate portlet within the portal. The mappings between subscriptions and portlets are stored in the preferences 320. Subscriptions for a particular device user may be updated in response to a request from the user to subscribe to a particular channel or topic name, or may be initiated by an administrator or a third party. When initiated by the device user, the portal handler 310 sends an MQTT subscribe message to the message processing component 210, including the client identifier and a channel/topic name. The message processing component responds by amending the stored subscription data 230. The portal handler 310 also updates its own local profile data 340. The portal handler then rearranges the portal page—selecting a suitable portal format if a format change is necessary, and updating the preferences to show an association between the new channel/topic and its assigned portlet.

Similarly, MQTT unsubscribe messages are sent by the portal handler in response to a user request to unsubscribe from a channel/topic, and the message processing component and the portal handler update their respective subscription and profile information. The portal handler then reformats the portal page if required. Stored subscriptions and the profile data held on a client device can also be updated in response to an administrator or a suitable-authorized third party.

In response to an information source sending publications via the portal server, messages are forwarded to subscriber client devices for display to the device user. The portlets to which specific topics are assigned are populated with the contents of these forwarded messages so as to display the message data on a device's user interface.

Within this environment, according to the present embodiment, portlets can also be dynamically arranged and rearranged in response to changes in location or use-context of a client device. A simple alphabetical list of locally-relevant subscribed-to services may be usable, but most mobile telephones are only capable of displaying a small list of items on their display screens and so some personalization of the display order is desirable to highlight priority items and for improved usability. A mechanism is provided for prioritizing a list of services based on patterns of use (such as frequency or times of use, whether the service is new to the client and whether a service is associated with other ones of the available services). This means the user can quickly see the most relevant services for the particular user, as determined with reference to their current location, personal profile and other context information.

This solution is differentiated from conventional systems which create personalized orderings since the conventional solutions require the entire list to be saved separately for each user. The mechanism described here and implemented according to the present invention only requires the complete service list to be stored once, with the personalized selection and ordering of services being performed on the client device.

In one embodiment of the invention, travel patterns are recorded by a third party through monitoring of the client's location. Bayesian statistics are then used to predict the likelihood of each service being required. The third party also records logs of service use by the client. This data is used to produce a personalized ordering for the service list specific to that client's travel and service usage history. The services are divided into ‘levels’ (or ‘groups’) based on how specific their corresponding location is. Ordering of these services within the level is done on an alpha-numeric basis. A level represents a discrete block of the continuous alpha-numeric series. Services with higher priority appear higher up the list, as do higher priority levels. A low priority service in a high priority level will appear higher than a high priority service in a low priority level. For example, the separate levels may be represented as follows:

| Level 1 | Level 2 | Level 3 |
|---|---|---|
| (1) Service1 | (10) Service10 | (100) Service100 |
| (2) Service2 | (11) Service11 | (101) Service101 |
| (3) Service3 | (12) Service12 | (102) Service102 |
| (4) Service4 | (13) Service13 | (103) Service103 |
| (5) Service5 | (14) Service14 | (104) Service104 |
| . . . | . . . | . . . |

In this way, a service's position within a level can be altered by adding to or subtracting from their priority identifiers. The level that a service belongs to can be altered by multiplying or dividing (in this case by 10). The level names can be something like location e.g. Level 1=UKLocations/CentralLondon/BuildingA, Level 2=UKLocations/CentralLondon, Level 3=UKLocations. The services could be Service 1=BuildingA fire alarm, Service 10=London Announcements, Service 100=UK Traffic news.

The monitoring third party stores the complete service list in its default order. In addition to this, the third party stores a personalized ordering function for each client. The personalized ordering function takes the form of a list of mathematical operations which, when applied to the default, result in the desired order. Operations may change a service's priority within a level or move it to a different level.

The client receives the list of available services and the personalized ordering function from the third party. By applying the personalized ordering function, the client can display the list with the correct prioritization. This can be represented as follows:

Default Service List:

```
  (1) Service1
  (2) Service2
  (3) Service3
  (4) Service4
  (5) Service5
  (6) Service6
  (7) Service7
  (8) Service8
  (9) Service9
(10) Service10
```

The Personalized Ordering Function (for example [(1)−1,(2)+1,(5)*2,(10)/2]) is built up by the broker using logs of the client device's locations and Bayesian statistics. For example if the client has just arrived in location C, having traveled through locations A and B to get there, the broker logs the chain A-B-C and then records which services the client uses. If the client uses Service10, then the next time they travel from A to B to C the broker weights Service10 more highly than other services (in this example, by multiplying its position by 2). The resulting reordered list may be as follows:

```
  (1) Service2
  (2) Service1
  (3) Service3
  (4) Service4
  (5) Service10
  (6) Service6
  (7) Service7
  (8) Service8
  (9) Service9
(10) Service5.
```

As a priority list this would appear as follows:

```
  (1) Service2
  (2) Service1
  (3) Service3
  (4) Service4
  (5) Service10
  (6) Service6
  (7) Service7
  (8) Service8
  (9) Service9
(10) Service5
```

In this example, Service2 has the highest priority and Service5 the lowest priority.

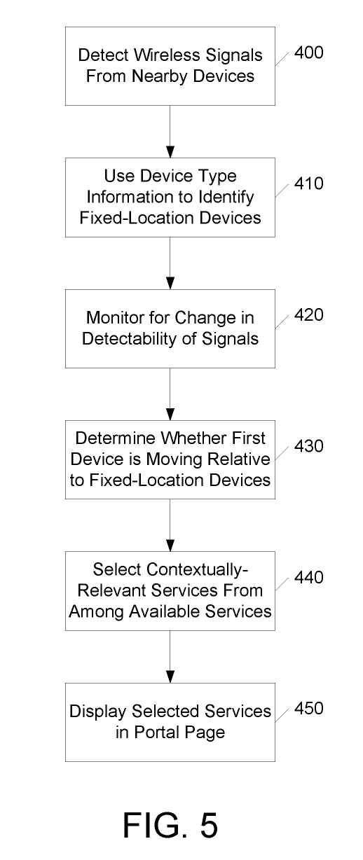

FIG. 5 shows a sequence of steps of a method for movement-determination according to an embodiment of the invention. A first communications device uses its Bluetooth or similar wireless signal detection capability to detect (400) wireless signals transmitted by other devices within the vicinity of the first device (i.e. if the first device is within their signal transmission range). The first communications device refers to mappings between device types (as specified within the detected signals) and certain categories (static and mobile) of device, to identify (410) from the detected signals a subset of the detected devices which are fixed-location devices. The first communications device then monitors (420) the detected wireless signals transmitted by the identified subset of devices, monitoring for changes in the detectability of signals transmitted by fixed-location devices, to determine (430) whether the first mobile communications device is moving relative to the fixed-location devices. This determination of whether or not the first device is moving is then factored into an automatic selection (440) of services from amongst a plurality of available services. The selection may involve filtering out certain services and/or prioritizing others. The selected services are then displayed (450) within a portal page of the first communications device, preferably in an order corresponding to the priority order of the device user.

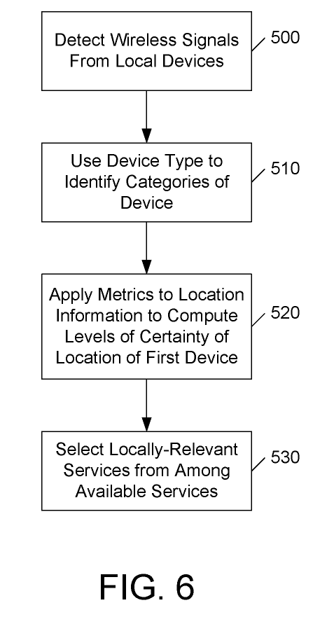

FIG. 6 shows a sequence of steps of a method for location-determination according to another embodiment of the invention. As described with reference to FIG. 5, a mobile communications device detects (500) wireless signals (in particular short-range wireless signals such as Bluetooth signals) that are transmitted by devices within the vicinity (signal transmission range) of the first mobile communications device. The detected signals include device type information and location information for the transmitter devices. The mobile device uses the device type data to identify (510) different categories of transmitter devices, including a subset which are fixed-location devices. The mobile device executes an algorithm that takes account of the different categories of detected device and the level of level of certainty of their transmitted location information, to determine (520) a location of the current device and to compute its level of certainty. That is, the location of the first mobile communications device is determined from the location information received from other detected devices, with greater emphasis on location information received from fixed-location devices than on location information received from mobile devices. This location information is then used to automatically select (530) locally-relevant services from a plurality of available services, based on the determined location of the first mobile communications device.

The present invention has applicability for a wide range of location-based services. Particular advantages have been identified for providing improved accessibility for sensorily-impaired people who can benefit from information such as fire alarm warnings being displayed as a high-priority item on their personal communications device to supplement the fire alarm warning sounds. Similarly, train announcement will not be heard clearly by all travelers whereas a text message sent to a portable device can make such information accessible to people who would otherwise be excluded from audio-only broadcasts of such information.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for accessing services from a first mobile communications device, comprising:
establishing a set of devices other than the first mobile communications device by detecting wireless signals transmitted by said devices;
identifying a subset of said detected devices that are fixed-location devices;
monitoring the detected wireless signals transmitted by said fixed-location devices to determine whether the first mobile communications device is moving relative to said fixed-location devices; and
selecting services from a plurality of available services according to said determination of whether the first mobile communications device is moving.

2. A method according to claim 1, wherein establishing a set of devices other than the first mobile communications device by detecting wireless signals transmitted by said devices further comprises detecting short range wireless signals to detect devices that are within a known approximate distance of the first mobile communications device, and wherein the determination of whether the first mobile device is moving is performed by monitoring the short range wireless signals received from fixed-location devices.

3. A method according to claim 2, wherein monitoring the detected wireless signals transmitted by said fixed-location devices to determine whether the first mobile communications device is moving relative to said fixed-location devices further comprises identifying a change in detected signal strength.

4. A method according to claim 3, wherein monitoring the detected wireless signals transmitted by said fixed-location devices to determine whether the first mobile communications device is moving relative to said fixed-location devices further comprises identifying when the first mobile device is unable to detect a signal from a previously detected fixed-location device and when the first mobile device is able to detect a signal from a previously-undetected fixed-location device.

5. A method according to claim 4, further comprising:
receiving location information from the set of detected devices; and
determining the location of the first mobile communications device using location information received from said detected devices, giving priority to location information received from fixed-location; and
selecting locally-relevant services based on the determined location of the first mobile communications device.

6. A method according to claim 5, wherein selecting locally-relevant services based on the determined location of the first mobile communications device further comprises selecting services based on stored subscriptions that specify services of interest to the device user, wherein at least one of the stored subscriptions is activated and/or deactivated in response to the determined location of the first mobile communications device.

7. A computer program product for accessing services from a first mobile communications device, said computer program product comprising a computer usable medium having computer usable program code embodied therewith, the computer usable program code comprising:
computer usable program code configured to establish a set of devices other than the first mobile communications device by detecting wireless signals transmitted by said devices;
computer usable program code configured to identify a subset of said detected devices that are fixed-location devices;
computer usable program code configured to monitor the detected wireless signals transmitted by said fixed-location devices to determine whether the first mobile communications device is moving relative to said fixed-location devices; and
computer usable program code configured to select services from a plurality of available services according to said determination of whether the first mobile communications device is moving.

8. A computer program product according to claim 7 wherein:
the computer usable program code configured to establish a set of devices other than the first mobile communications device by detecting wireless signals transmitted by said devices further comprises computer usable program code configured to detect short range wireless signals to detect devices that are within a known approximate distance of the first mobile communications device, and
the computer usable program code configured to monitor the detected wireless signals transmitted by said fixed-location devices to determine whether the first mobile communications device is moving relative to said fixed-location devices further comprises computer usable program code configured to monitor the short range wireless signals received from fixed-location devices.

9. A computer program product according to claim 8 wherein the computer usable program code configured to monitor the detected wireless signals transmitted by said fixed-location devices to determine whether the first mobile communications device is moving relative to said fixed-location devices further comprises computer usable program code configured to identify a change in detected signal strength.

10. A computer program product according to claim 9 wherein the computer usable program code configured to monitor the detected wireless signals transmitted by said fixed-location devices to determine whether the first mobile communications device is moving relative to said fixed-location devices further comprises computer usable program code configured to identify when the first mobile device is unable to detect a signal from a previously detected fixed-location device and when the first mobile device is able to detect a signal from a previously-undetected fixed-location device.

11. A computer program product according to claim 10 further comprising:
computer usable program code configured to receive location information from the set of detected devices; and
computer usable program code configured to determine the location of the first mobile communications device using location information received from said detected devices, giving priority to location information received from fixed-location; and
computer usable program code configured to select locally-relevant services based on the determined location of the first mobile communications device.

12. A computer program product according to claim 11 wherein the computer usable program code configured to select locally-relevant services based on the determined location of the first mobile communications device further comprises computer usable program code configured to select services based on stored subscriptions that specify services of interest to the device user, wherein at least one of the stored subscriptions is activated and/or deactivated in response to the determined location of the first mobile communications device.

13. A mobile communications apparatus comprising:
means for establishing a set of devices other than the mobile communications apparatus by detecting wireless signals transmitted by said devices;
means for identifying a subset of said detected devices that are fixed-location devices;
means for monitoring the detected wireless signals transmitted by said fixed-location devices;
logic means for determining from the monitored signals whether the mobile communications apparatus is moving relative to said fixed-location devices; and
means for selecting services from a plurality of available services according to said determination of whether the mobile communications apparatus is moving.

14. A mobile communications apparatus according to claim 13 wherein the means for establishing a set of devices other than the mobile communications apparatus by detecting wireless signals transmitted by said devices further comprises means for detecting short range wireless signals to detect devices that are within a known approximate distance of the mobile communications apparatus, and wherein the determination of whether the mobile communications apparatus is moving is performed by monitoring the short range wireless signals received from fixed-location devices.

15. A mobile communications apparatus according to claim 14 wherein the logic means for determining from the monitored signals whether the mobile communications apparatus is moving relative to said fixed-location devices further comprises means for identifying a change in detected signal strength.

16. A mobile communications apparatus according to claim 15 wherein the logic means for determining from the monitored signals whether the mobile communications apparatus is moving relative to said fixed-location devices further comprises:
means for identifying when the mobile communications apparatus is unable to detect a signal from a previously detected fixed-location device; and
means for identifying when mobile communications apparatus is able to detect a signal from a previously-undetected fixed-location device.

17. A mobile communications apparatus according to claim 16 further comprising:
means for receiving location information from the set of detected devices; and means for determining the location of the mobile communications apparatus using location information received from said detected devices, giving priority to location information received from fixed-location; and
means for selecting locally-relevant services based on the determined location of the mobile communications apparatus.

18. A mobile communications apparatus according to claim 17 wherein the means for selecting locally-relevant services based on the determined location of the first mobile communications apparatus further comprises selecting means for selecting services based on stored subscriptions that specify services of interest to the device user, wherein at least one of the stored subscriptions is activated and/or deactivated in response to the determined location of the mobile communications apparatus.
